(19) United States
(12) Patent Application Publication
(10) Pub. No.: US 2025/0299162 A1
(43) Pub. Date: Sep. 25, 2025

(54) METHOD, APPARATUS, AND PROGRAM FOR APPOINTMENT MANAGEMENT, AND APPOINTMENT MANAGEMENT SYSTEM

(71) Applicant: RISO KAGAKU CORPORATION, Tokyo (JP)

(72) Inventors: Nobuyuki NAKAYAMA, Tokyo (JP); Junko KATO, Tokyo (JP)

(73) Assignee: RISO KAGAKU CORPORATION, Tokyo (JP)

(21) Appl. No.: 19/079,993

(22) Filed: Mar. 14, 2025

(30) Foreign Application Priority Data
Mar. 22, 2024 (JP) 2024-046660
Dec. 4, 2024 (JP) 2024-211846

(51) Int. Cl. G06Q 10/1093; G06Q 50/20

(52) U.S. Cl. CPC G06Q 10/1095; G06Q 50/20

(57) ABSTRACT

An appointment management apparatus includes: an appointment slot setting unit in which a plurality of appointment slots prepared by a host are set in advance; a guest attribute information storage unit that stores attribute information of a plurality of guests who make appointments from among the plurality of appointment slots; a candidate appointment slot identifying unit that identifies candidate appointment slots for each guest based on the attribute information of each guest and outputs the candidate appointment slots to a terminal device of each guest; a desired appointment slot receiving unit that receives a desired appointment slot selected by each guest from among the candidate appointment slots for each guest; and an assigning unit that assigns an appointment for each guest from among the plurality of appointment slots based on the desired appointment slot of each guest and the attribute information of each guest.

### CROSS-REFERENCE TO RELATED APPLICATIONS

The present application claims priority under 35 U.S.C. § 119 to Japanese Patent Application No. 2024-046660, filed on Mar. 22, 2024 and Japanese Patent Application No. 2024-211846, filed on Dec. 4, 2024. The above applications are hereby expressly incorporated by reference, in these entireties, into the present application.

### BACKGROUND OF THE INVENTION

### 1. Field of the Invention

The present disclosure is related to an appointment management apparatus, an appointment management method, an appointment management program and an appointment management system for assigning guest appointments to appointment slots prepared by a host.

### 2. Description of the Related Art

Conventionally, when a teacher at a school meets with guardians of students, it is necessary to coordinate the date and time of the meeting with all guardians. Generally, all guardians are asked to answer a questionnaire regarding their preferred dates and times, and the school schedules meetings to suit their preferred dates and times.

In this case, there are some guardians with whom meetings should be held earlier in the day from the viewpoint of the school, and there are some guardians with whom meetings should be held in the last slot of the day for longer meetings. Therefore, the schedule needs to be adjusted to take these circumstances into consideration. In addition, it is necessary to send out rescheduling requests to guardians with whom meetings cannot be held on their desired dates. However, it is very time consuming to send such requests and to adjust the schedule after the rescheduling.

Japanese Unexamined Patent Publication No. 2021-170151 proposes a meeting schedule adjustment apparatus that enables adjustment of schedules for interviews between a recruiter and a job seeker to be facilitated. Specifically, Japanese Unexamined Patent Publication No. 2021-170151 proposes an interview schedule adjustment apparatus that identifies a plurality of dates and times when interviews can be held, based on schedule information of the recruiter.

### SUMMARY OF THE INVENTION

However, in Japanese Unexamined Patent Publication No. 2021-170151, the availability of the recruiter (interviewer) is referenced, but the availability of the job seeker (interviewee) is not. Therefore, the interview date is not necessarily convenient for the job seeker, resulting in the problem of frequent rescheduling.

The present disclosure has been developed in view of the foregoing circumstances. The present disclosure provides a method, an apparatus, and a program for appointment management, and an appointment management system capable of reducing the number of rescheduling procedures and efficiently adjusting schedules without an undue burden.

The appointment management apparatus of the present disclosure is equipped with an appointment slot setting unit in which a plurality of appointment slots prepared by a host are set in advance, a guest attribute information storage unit that stores attribute information of a plurality of guests who make appointments from among the plurality of appointment slots, a candidate appointment slot identifying unit that identifies candidate appointment slots for each guest based on the attribute information of each guest and outputs the candidate appointment slots to a terminal device of each guest, a desired appointment slot receiving unit that receives a desired appointment slot selected by each guest from among the candidate appointment slots for each guest, and an assigning unit that assigns an appointment for each guest from among the plurality of appointment slots based on the desired appointment slot of each guest and the attribute information of each guest.

According to the appointment management apparatus of the present disclosure, the appointment management apparatus identifies candidate appointment slots for each guest based on the attribute information of each guest and outputs the candidate appointment slots to the terminal device of each guest, receives a desired appointment slot selected by each guest from among the candidate appointment slots for each guest, and assigns an appointment for each guest from among a plurality of appointment slots based on the desired appointment slot of each guest and the attribute information of each guest. Therefore, the number of times of rescheduling procedures can be reduced and a schedule can be adjusted efficiently and without an undue burden.

### BRIEF DESCRIPTION OF THE DRAWINGS

FIG. 1 is a block diagram that illustrates the schematic configuration of an appointment management system using an embodiment of the appointment management apparatus of the present disclosure.

FIG. 2 is a diagram that illustrates an example of preset appointment slots.

FIG. 3 is a diagram that illustrates an example of an attribute information table that shows attribute information of each guardian.

FIG. 4 is a diagram that illustrates an example of candidate appointment slots for each guardian.

FIG. 5 is a diagram that illustrates an example of a schedule with appointments assigned to each guardian from among a plurality of appointment slots.

FIG. 6 is a sequence diagram for explaining the flow of processes performed by the appointment management system illustrated in FIG. 1.

### DETAILED DESCRIPTION OF THE EMBODIMENTS

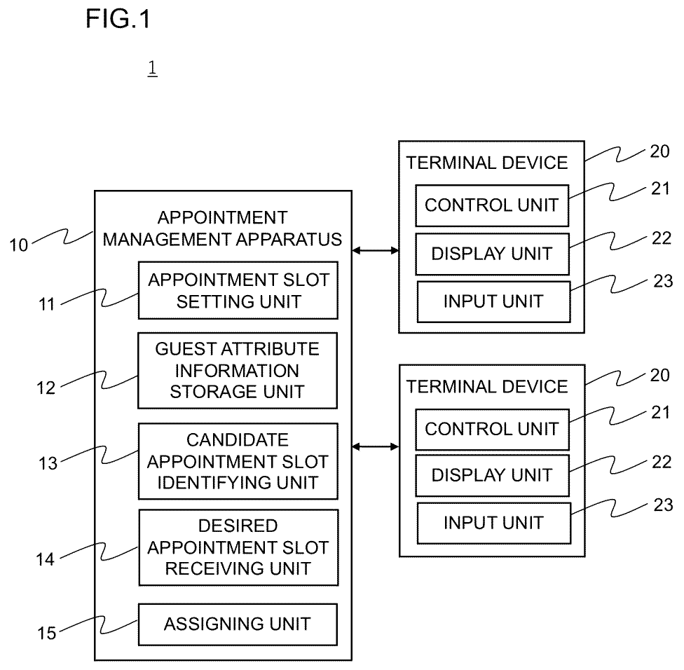

An appointment management system that employs an embodiment of an appointment management apparatus of the present disclosure will be described in detail below with reference to the drawings. FIG. 1 is a block diagram that illustrates the schematic configuration of an appointment management system 1 of the present embodiment.

The appointment management system 1 of the present embodiment is a system for scheduling meetings between school teachers and guardians of students who attend the school. The appointment management system 1 is equipped with an appointment management apparatus 10 and terminal devices 20 of the guardians. Only two terminal devices 20 of the guardians are illustrated in FIG. 1. However, in reality, many terminal devices 20 of the guardians are connected to one appointment management apparatus 10.

The appointment management apparatus 10 and the terminal devices 20 of the guardians are connected by a communication network such as the Internet such that they are capable of communicating with each other.

The appointment management system 1 of the present embodiment identifies candidate appointment slots for a schedule of meetings for guardians based on attribute information of each of the guardians which is known by the school, and presents the candidate appointment slots to the guardians. Then, the appointment management system 1 receives desired appointment slots selected by the guardians from among the presented candidate appointment slots. Next, the appointment management system 1 assigns an appointment to each of the guardians based on the received desired appointment slots from among a plurality of preset appointment slots. In the present embodiment, the school (teacher) corresponds to the host of the present disclosure, and the guardians correspond to the guests of the present disclosure.

The following is a detailed description of each of the components that constitute the appointment management system 1 of the present embodiment.

The appointment management apparatus 10 has an appointment slot setting unit 11, a guest attribute information storage unit 12, a candidate appointment slot identifying unit 13, a desired appointment slot receiving unit 14, and an assigning unit 15.

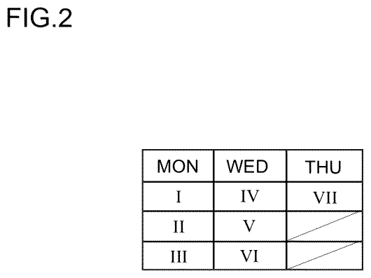

A plurality of appointment slots prepared by the school (teacher) are set in advance in the appointment slot setting unit 11. The appointment slots are set and entered, for example, on a terminal device (not shown) owned by a teacher, and set in the appointment slot setting unit 11. FIG. 2 illustrates an example of available appointment slots. In FIG. 2, three appointment slots (I to III) are set for Monday, three appointment slots (IV to VI) are set for Tuesday, and one appointment slot (VII) is set for Thursday.

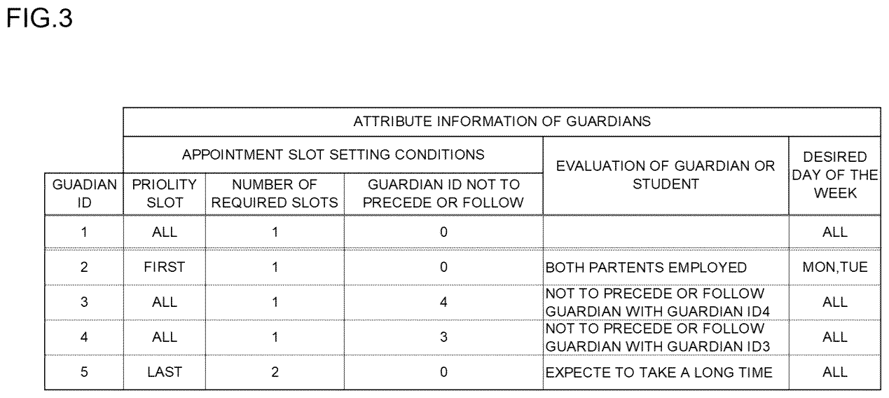

The guest attribute information storage unit 12 stores attribute information of multiple guardians who make appointments from among a plurality of appointment slots. FIG. 3 illustrates an example of an attribute information table in which guardian IDs are correlated to the attribute information of guardians. The guardian IDs are identification information assigned to each guardian.

As illustrated in FIG. 3, the present embodiment stores evaluation information regarding the guardians and students, appointment slot setting conditions set based on the evaluation information, and preferred days of the week for each of the guardians as the attribute information of the guardians.

The evaluation information regarding the guardians includes information regarding the employment status of the guardians, information regarding evaluations of the guardians from the viewpoint of the school (teachers), and information regarding personal relationships of the guardians, for example.

Information regarding the employment status of the guardians includes information such as the type of work the guardians do and whether both parents (guardians) are employed. Information regarding the evaluation of guardians from the viewpoint of the school (teachers) includes information such as “takes a long time in meetings” and “not punctual” (likely to be late for meetings), for example. In addition, information regarding the personal relationships of the guardians includes information regarding guardians who should not have their appointment slots immediately preceding or following each other, for example.

The evaluation information regarding students includes the student's academic performance and other evaluation information, as well as information regarding whether the student has siblings within the same school. If the student's academic performance is poor, the “meeting will take longer”, and if the student has siblings within the same school, the appointment slots for the siblings should be arranged on the same day, or the appointment slots should immediately precede or follow each other.

The appointment slot setting conditions are appointment slot setting conditions which are set based on the evaluation information regarding guardians and students as described above. In the present embodiment, priority slots, the number of required slots, and the guardian IDs of guardians for whom appointment slots should not immediately precede or follow each other are stored as the appointment slot setting conditions. The priority slots indicate conditions for the priority appointment slots. In the case that the priority slot is “ALL”, it means all slots, “first” means the first slot of each meeting date, and “last” means the last slot of each meeting date. For example, if the evaluation information regarding the guardian is “both parents working”, “first” is set as the priority slot because it is better to finish the meeting as early as possible.

In the case that the evaluation information regarding the guardian indicates that the meeting will take a long time, or in the case that the evaluation information regarding the student indicates that there is a problem with his/her academic performance, “last” is set as the priority slot because the meeting will take a long time.

The number of required slots indicates the number of appointment slots needed for one meeting. The number of required slots is usually “1” and the number of required slots increases depending on the evaluation information regarding the guardians and the student. For example, if the evaluation information regarding the guardian indicates that the meeting will take time, or if the student's evaluation information indicates that there is a problem with his/her academic performance, the meeting will require more time, so the number of required slots will be set to a plurality of slots.

The not to precede or follow guardians indicates the guardian ID's of guardians whose appointment slots can not precede or follow each other. For example, in the example of the attribute information table illustrated in FIG. 3, the evaluation information of the guardian with guardian ID 3 is “not to precede or follow the guardian with ID 4”. The guardian ID “4” is stored as a guardian ID not to precede or follow the guardian with ID 3, and the guardian ID “3” is stored as a guardian ID not to precede or follow the guardian with ID 4.

The guardian's preferred day of the week information is information regarding the preferred day of the week for an appointment which was previously answered by a guardian. The information regarding the preferred day of the week “ALL” means that a guardian is available any day of the week.

The candidate appointment slot identifying unit 13 identifies candidate appointment slots for each guardian and outputs them to the terminal device 20 of each guardian, based on the attribute information of each guardian described above.

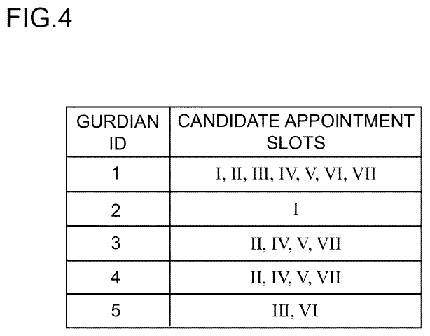

Here, how the candidate appointment slot identifying unit 13 identifies a candidate appointment slot for each guardian with respect to the appointment slots illustrated in FIG. 2 by referring to the attribute information table illustrated in FIG. 3 will be described. FIG. 4 illustrates an example of candidate appointment slots for each guardian.

The candidate appointment slot identifying unit 13 first refers to the priority slots in the attribute information of the guardian in the attribute information table illustrated in FIG. 3. In the example of the attribute information table illustrated in FIG. 3, “first” is set as a priority slot for the guardian with guardian ID 2, and “last” is set as a priority slot for the guardian with guardian ID 5. In addition, “Monday” and “Tuesday” are set as the preferred days of the week for the guardian with guardian ID 2, and “ALL” is set as the preferred days of the week for the guardian with guardian ID 5.

Therefore, the candidate appointment slot identifying unit 13 first identifies appointment slot I as a candidate appointment slot for the guardian with guardian ID 2, and then identifies appointment slots III and VI as candidate appointment slots for the guardian with guardian ID 5. Note that in the present embodiment, appointment slot VII is presumed to be simply a vacant time slot, although no appointment slot is subsequently set, and is not the “last” appointment slot.

Next, the candidate appointment slot identifying unit 13 refers to the number of required slots in the attribute information of the guardian. In the example of the attribute information table illustrated in FIG. 3, “2” is set for the number of required slots for the guardian with guardian ID 5, and “last” is set for the priority slot for the guardian with guardian ID 5. That is, in the case that a guardian is assigned the last appointment slot, it is not necessary to take a next guardian's appointment slot into consideration. Therefore, the candidate appointment slot is not affected in the present embodiment. Note that in the case that “last” is not set as a guardian's priority slot and the number of required slots is “2”, for example, two consecutive appointment slots will be identified as candidate appointment slots.

Next, the candidate appointment slot identifying unit 13 refers to the guardian IDs which can not have appointments preceding or following each other. In the example of the attribute information table illustrated in FIG. 3, guardian ID 4 is set for guardian ID 3 and guardian ID 3 is set for guardian ID 4. For the guardians having guardian ID 3 and guardian ID 4, the information of the desired day of the week is “ALL”. Therefore, appointment slots II, IV, V, and VII which are appointment slots other than those for guardian ID 2 and guardian ID 5 are identified as candidate appointment slots.

Finally, the candidate appointment slot identifying unit 13 identifies candidate appointment slots for guardian ID 1 who can set their appointment slot most freely. In the present embodiment, all of the appointment slots I through VII are identified as candidate appointment slots for the guardian with guardian ID 1.

As described above, the candidate appointment slot identifying unit 13 first identifies rough candidate appointment slots by referring to the information regarding priority slots, the number of slots required, and preferred days of the week among the attribute information of the guardians. Note that in the case that the evaluation information regarding a student indicate that the student has siblings in the same school, appointment slots on the same day of the week are identified as candidate appointment slots, or preceding or following appointment slots are included in the candidate appointment slots for the siblings.

Then, the candidate appointment slot identifying unit 13 outputs the candidate appointment slots which are identified for each guardian as described above to the terminal device 20 of each guardian. Note that the guardian ID of each guardian and the identification information of the terminal device 20 of each guardian are correlated in advance, and the candidate appointment slot identifying unit 13 outputs the candidate appointment slots corresponding to a given guardian ID to the terminal device 20 with identification information correlated to that guardian ID.

A guardian selects a desired appointment slot from among the candidate appointment slots output to the terminal device 20 and outputs it to the appointment management apparatus 10.

The desired appointment slot receiving unit 14 receives each guardian's desired appointment slot which is output from the terminal device 20 of each guardian.

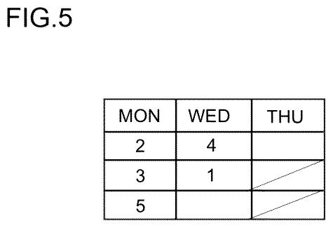

The assigning unit 15 assigns an appointment to each guardian from among a plurality of appointment slots based on the desired appointment slot for each of the guardians which is received by the desired appointment slot receiving unit 14 and the attribute information of the guardians to complete an ultimately determined appointment schedule. FIG. 5 illustrates an example of a completed appointment schedule.

The assigning unit 15 assigns appointment slots starting from the guardians whose meetings are expected to take longer. Specifically, the assigning unit 15 assigns appointment slots first to those guardians whose priority slot is set to “last” or who have multiple appointment slots set in the number of required slots. For example, if the desired appointment slot for guardian ID 5 whose priority slot is “last” is appointment slot III, the appointment for the guardian ID 5 is assigned to appointment slot III.

Next, the assigning unit 15 assigns an appointment slot for guardians whose priority slots are set to “first”. For example, if the desired appointment slot for guardian ID 2 whose priority slot is “first” is appointment slot I, then the appointment for guardian ID 2 is assigned to appointment slot I.

The assigning unit 15 then refers to the guardians who are not to have appointments preceding or following each other among the attribute information of the guardians. In the example of the attribute information table illustrated in FIG. 3, the guardian ID “4” is stored as a guardian ID who is not to have an appointment preceding or following guardian ID 3, and the guardian ID “3” is stored as a guardian ID who is not to have an appointment preceding or following guardian ID 4.

Therefore, appointments are assigned such that the appointment slots for the guardian with guardian ID 3 and the guardian with guardian ID 4 do not precede or follow each other. Specifically, the assigning unit 15 assigns the appointment slots for the guardian with guardian ID 3 and the guardian with guardian ID 4 such that the combination of the appointment slots for the guardian with guardian ID 3 and the guardian with guardian ID 4 are one of appointment slot II and appointment slot IV, appointment slot II and appointment slot V, appointment slot II and appointment slot VII, appointment slot IV and appointment slot VII, and appointment slot V and appointment slot VII. FIG. 5 illustrates a schedule in the case that the desired appointment slot for the guardian with guardian ID 3 is appointment slot II and the desired appointment slot for the guardian with guardian ID 4 is appointment slot IV.

Finally, the assigning unit 15 assigns one of the appointment slots V, VI, or VII to the guardian with guardian ID 1. FIG. 5 illustrates a schedule in the case that the desired appointment slot for the guardian with guardian ID 1 is appointment slot V.

After all of the guardians have been assigned to their appointment slots, the assigning unit 15 outputs the ultimately determined appointment slots for each guardian to the terminal device 20 of each guardian. In the case that the evaluation information of a student indicates that the student has siblings in the same school, the assigning unit 15 assigns an appointment slot for the same day of the week for the siblings, or assigns appointment slots that precede or follow each other, in the same manner as when identifying candidate appointment slots.

Here, as a result of assignments by the assigning unit 15 based on the attribute information and the desired appointment slots of the guardians as described above, some guardians may not be assigned to their desired appointment slots. In such cases, the assigning unit 15 notifies the terminal devices 20 of such guardians of a request to change their desired appointment slot. When notifying the terminal devices 20 of the guardians of the request for a change, the assigning unit 15 outputs information regarding available appointment slots together with the request.

The guardian then selects desired appointment slots again from among the available appointment slots and outputs the desired appointment slots to the appointment management apparatus 10.

The assigning unit 15 reassigns the appointment slots to the available slots based on the changed desired appointment slots. The assigning unit 15 repeats the notification of requests for change and reassignment until the assignment of appointment slots to all of the guardians is completed.

In addition, the assigning unit 15 may set priority appointment information for the guardian ID of a guardian who has changed their desired appointment slot as described above, such that the guardian will be given priority when assigning appointment slots for next and subsequent meetings. The assigning unit 15 may then assign a desired appointment slot with the highest priority when assigning appointment slots for next and subsequent meetings to the guardian with the guardian ID for whom the priority appointment information has been set.

The appointment management apparatus 10 has a CPU (Central Processing Unit), a semiconductor memory such as a ROM (Read Only Memory) and a RAM (Random Access Memory), a storage such as a hard disk, and a communication I/F (Interface).

An appointment management program, which is a web application, is installed in the storage of the appointment management apparatus 10. When this appointment management program is launched by the CPU, the functions of each component of the appointment management apparatus 10 are executed.

Some or all of the functions of the appointment management program may be executed by an ASIC (Application Specific Integrated Circuit), an FPGA (Field Programmable Gate Array), or hardware such as other electrical circuits.

The terminal device 20 of the guardian has a control unit 21. The control unit 21 controls the entirety of the terminal device 20. Particularly, the control unit 21 displays candidate appointment slots which are output from the appointment management apparatus 10 on a display unit 22, and outputs desired appointment slots which have been set and input at an input unit 23 to the appointment management apparatus 10.

The display unit 22 is constituted by a display device such as a liquid crystal display, and the input unit 23 is constituted by an input device such as a mouse or a keyboard.

Note that in the case that a tablet terminal or a smartphone is employed as the terminal device 20, the touch panel of the tablet terminal or the smartphone functions as both the display unit 22 and the input unit 23.

The terminal device 20 is equipped with a CPU, a semiconductor memory such as a ROM and a RAM, a storage such as a hard disk, and a communication I/F.

An application for guardians is installed in the storage of the terminal device 20. When this application for guardians is launched by the CPU, candidate appointment slots are displayed on the terminal device 20, and desired appointment slots can be set and entered. Note that an application for guardians which is provided via a web browser may be utilized instead of the application for guardians which is installed on the storage device as in the present embodiment.

Some or all of the functions of the application for guardians may be executed by hardware such as an ASIC, an FPGA, or other electrical circuits.

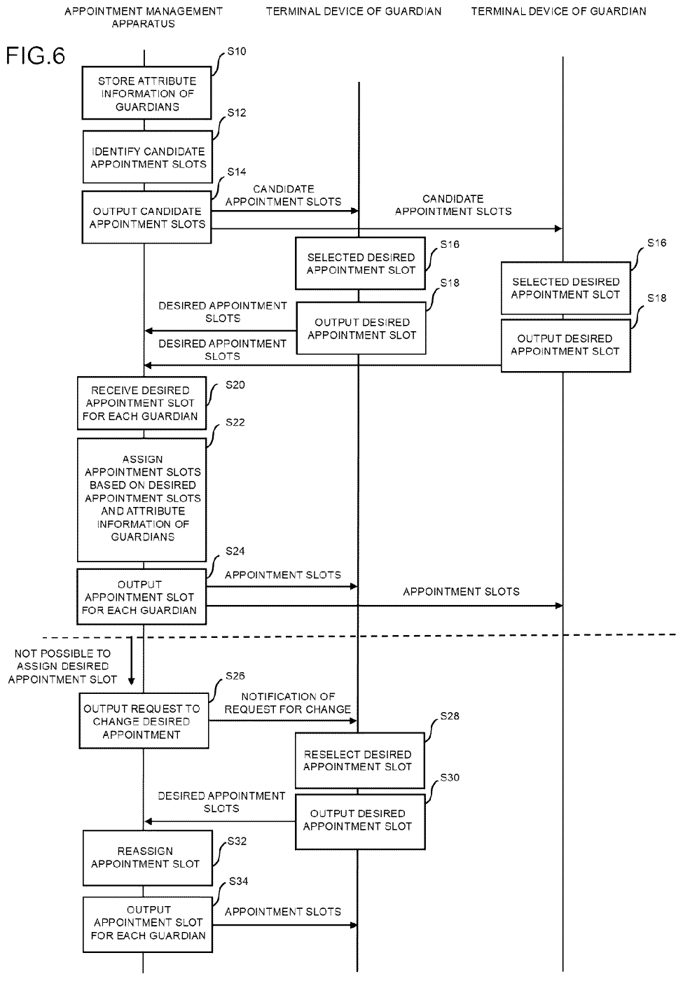

Next, the flow of processes performed by the appointment management system 1 of the present embodiment will be explained with reference to the sequence diagram illustrated in FIG. 6.

First, attribute information for each guardian as illustrated in FIG. 3 is stored at the appointment management apparatus 10 (S10).

Next, a candidate appointment slot for each guardian is identified based on the attribute information for each guardian (S12), as illustrated in FIG. 4, and the candidate appointment slots are output to each of the terminal devices 20 of the guardians (S14).

Then, each of the guardian reviews the candidate appointment slots which are output from the appointment management apparatus 10 on the terminal device 20, selects a desired appointment slot from among the candidate appointment slots (S16), and outputs the selected desired appointment slot to the appointment management apparatus 10 (S18).

The appointment management apparatus 10 receives the desired appointment slots which are output from each of the terminal devices 20 of the guardians (S20) and assigns an appointment slot to each of the guardians based on the desired appointment slot which is output from each of the terminal devices 20 of the guardians and the attribute information of each of the guardians (S22).

The appointment management apparatus 10 then outputs the appointment slots which are assigned to each guardian to the terminal device 20 of each guardian (S24).

If, as a result of assignments based on the attribute information of the guardians and the desired appointment slots of the guardians described above, the appointment management apparatus 10 is unable to assign a desired appointment slot to a guardian, the appointment management apparatus 10 notifies the terminal device 20 of the guardian of a request to change the desired appointment slot (S26).

The guardian then selects a desired appointment slot again from available appointment slots (S28) and outputs the desired appointment slot to the appointment management apparatus 10 (S30).

Then, the appointment management apparatus 10 repeats the notification of request for change and reassignment until the assignment of appointment slots to all of the guardians is completed (S32).

When the assignment of appointment slots to all of the guardians is completed, the appointment management apparatus 10 outputs the appointment slots for each guardian to each of the terminal devices 20 of the guardians (S34).

According to the appointment management system 1 of the above embodiment, candidate appointment slots are identified for each guardian based on the attribute information of each guardian and output to the terminal device 20 of each guardian. Desired appointment slots selected by each guardian from among the candidate appointment slots for each guardian are received. Then, an appointment for each guardian is assigned to an appointment slot from among a plurality of appointment slots based on the desired appointment slot of each guardian and the attribute information of each guardian. Thereby, the number of rescheduling procedures can be reduced, and schedules can be adjusted efficiently without an undue burden.

In addition, in the appointment management system 1 of the above embodiment, the terminal devices 20 of guardians to whom desired appointment slots cannot be assigned are notified of a request to change their desired appointment slot. Appointment slots are reassigned for such guardians based on the desired appointment slot which is changed in response to the request for a change, and the notification of the request for a change and reassignment are repeated until the assignment of appointment slots to all of the guardians is completed. Therefore, appointment slots can be positively assigned to each guardian and desired appointment slots can be efficiently assigned to each guardian.

Further, in the appointment management system 1 of the above embodiment, in the case that priority appointment information is added to a guardian who changed their desired appointment slot to give priority in assigning appointment slots for next and subsequent meetings, the system can provide an advantage to guardian who change their desired appointment slot. Therefore, changes in desired appointment slots by guardians can be conducted more smoothly.

Still further, in the appointment management system 1 of the above embodiment, the attribute information of the guardian is set based on the evaluation of the guardian or student. Therefore, the evaluation of the guardian from the viewpoint of the school can be reflected in the allocation of appointment slots, and more appropriate scheduling can be conducted.

The appointment management system 1 of the above embodiment is an example in which the present disclosure is applied to appointments for meetings between teachers and guardians. However, the present disclosure is not limited to such a configuration, and may be employed to determine other appointments. The present disclosure may be applied to appointments at hospitals, restaurants, and tickets, for example.

In the case that the present disclosure is applied to appointments at a hospital, for example, appointment slots are set for each department. Then, a history of previous visit dates and times, and whether the visit is expected to take time may be employed as attribute information of a guest, for example. Based on such attribute information, candidate appointment slots are identified and assigned. Specifically, if a patient has visited on a certain day of the week and time based on the history of previous visit dates and times, for example, the same day of the week and time can be identified as a candidate appointment slot, and an appointment can be assigned. It is also possible to identify and assign more appointment slots to patients who require more time for explanations of medical conditions.

In the case that the present disclosure is applied to reservations at a restaurant, for example, the appointment slot is set to the restaurant's business hours on a given day. Then, information such as the number of repeat visits, the amount of money spent so far, and the time of day of past visits to the restaurant may be employed as attribute information of a guest, for example. Based on such attribute information, candidate appointment slots are identified and appointment slots are assigned. Specifically, customers with a high number of repeat visits and customers with a high amount of money spent, for example, may be prioritized as important customers and appointment slots can be identified and assigned. Alternatively, appointment slots can be identified and assigned with priority given to the time of day of a previous visit.

In the case that the present disclosure is applied to a ticket reservation system, for example, the appointment slot is set to the date and time of a performance. The number of times a guest has repeated reservations, and in the case that tickets are drawn by lottery, information regarding the rate of winning or losing previous tickets may be employed as attribute information of a guest. Based on such attribute information, candidate appointment slots are identified and appointments are assigned. Specifically, for example, if a repeat guest has a rate of winning or losing less than a certain value, he or she may be given priority to be identified as a candidate for an appointment slot and be assigned a ticket reservation.

Note that the present disclosure is not limited to the above embodiments, but may be realized by modifying the components to an extent that does not depart from the spirit thereof at the implementation stage. Also, various inventions may be formed by appropriate combinations of the plurality of components disclosed in the above embodiments. For example, all of the components described in the embodiments may be combined as appropriate. It is, of course, possible to make various modifications and applications within the scope that does not depart from the spirit of the disclosure.

The following items are further disclosed with respect to the present disclosure.

### Item 1

An appointment management apparatus of the present disclosure is equipped with an appointment slot setting unit in which a plurality of appointment slots prepared by a host are set in advance, a guest attribute information storage unit that stores attribute information of a plurality of guests who make appointments from among the plurality of appointment slots, a candidate appointment slot identifying unit that identifies candidate appointment slots for each guest based on the attribute information of each guest and outputs the candidate appointment slots to a terminal device of each guest, a desired appointment slot receiving unit that receives a desired appointment slot selected by each guest from among the candidate appointment slots for each guest, and an assigning unit that assigns an appointment for each guest from among the plurality of appointment slots based on the desired appointment slot of each guest and the attribute information of each guest.

### Item 2

In the appointment management apparatus of Item 1, the assigning unit may notify the terminal device of a guest for whom a desired appointment slot cannot be assigned of a request to change the desired appointment slot, reassign an appointment slot based on a desired appointment slot which is changed in response to the request for a change, and repeat the notification of the request for a change and reassignment until the assignment of appointment slots to all guests is completed.

### Item 3

In the appointment management apparatus of Item 1 or 2, the assigning unit may add priority appointment information to a guest who has changed their desired appointment slot, that gives priority in the assignment of appointment slots for next and subsequent appointments.

### Item 4

In the appointment management apparatus of any of Items 1 through 3, the attribute information of a guest may be set based on an evaluation of the guest.

### Item 5

In the appointment management apparatus of any of Items 1 through 4, the host may be a school, the guest may be a guardian of a student attending the school, and the appointment slot may be an appointment slot for a meeting between a school teacher and a guardian.

### Item 6

In the appointment management apparatus of Item 5, the attribute information of the guest may be set based on an evaluation of the student or the guardian.

### Item 7

An appointment management system of the present disclosure is equipped with the appointment management apparatus of any of Items 1 through 6 and a terminal device of a guest.

### Item 8

An appointment management method of the present disclosure sets a plurality of appointment slots prepared by a host in advance, stores attribute information of a plurality of guests who make appointments from among the plurality of appointment slots in advance, identifies candidate appointment slots for each guest based on the attribute information of each guest, outputs the candidate appointment slots to a terminal device of each guest, receives a desired appointment slot which is selected by each guest from among the candidate appointment slots for each guest, and assigns an appointment to each guest from among the plurality of appointment slots based on the desired appointment slot of each guest and the attribute information of each guest.

### Item 9

An appointment management program of the present disclosure causes a computer to execute a step of setting a plurality of appointment slots prepared by a host in advance, a step of storing attribute information of a plurality of guests who make appointments from among the plurality of appointment slots in advance, a step of identifying candidate appointment slots for each guest based on the attribute information of each guest, a step of outputting the candidate appointment slots to a terminal device of each guest, a step of receiving a desired appointment slot which is selected by each guest from among the candidate appointment slots for each guest, and a step of assigning an appointment to each guest from among the plurality of appointment slots based on the desired appointment slot of each guest and the attribute information of each guest.

### EXPLANATION OF THE REFERENCE NUMERALS

1 appointment management system
10 appointment management apparatus
11 appointment slot setting unit
12 guest attribute information storage unit
13 candidate appointment slot identifying unit
14 desired appointment slot receiving unit
15 assigning unit
20 terminal device
21 control unit
22 display unit
23 input unit

What is claimed is:

1. An appointment management apparatus comprising:
an appointment slot setting unit in which a plurality of appointment slots prepared by a host are set in advance;
a guest attribute information storage unit that stores attribute information of a plurality of guests who make appointments from among the plurality of appointment slots;
a candidate appointment slot identifying unit that identifies candidate appointment slots for each guest based on the attribute information of each guest and outputs the candidate appointment slots to a terminal device of each guest;
a desired appointment slot receiving unit that receives a desired appointment slot selected by each guest from among the candidate appointment slots for each guest; and
an assigning unit that assigns an appointment for each guest from among the plurality of appointment slots based on the desired appointment slot of each guest and the attribute information of each guest.

2. The appointment management apparatus according to claim 1, wherein:
the assigning unit notifies the terminal device of a guest for whom a desired appointment slot cannot be assigned of a request to change the desired appointment slot, reassigns an appointment slot based on a desired appointment slot which is changed in response to the request for a change, and repeats the notification of the request for a change and reassignment until the assignment of appointment slots to all guests is completed.

3. The appointment management apparatus according to claim 2, wherein:
the assigning unit adds priority appointment information to a guest who has changed their desired appointment slot, that gives priority in the assignment of appointment slots for next and subsequent appointments.

4. The appointment management apparatus according to any of claim 1, wherein:
the attribute information of a guest is set based on an evaluation of the guest.

5. The appointment management apparatus according to any of claim 1, wherein:
the host is a school,
the guest is a guardian of a student attending the school, and
the appointment slot is an appointment slot for a meeting between a school teacher and a guardian.

6. The appointment management apparatus according to claim 5, wherein:
the attribute information of the guest is set based on an evaluation of the student or the guardian.

7. An appointment management system comprising:
the appointment management apparatus according to claim 1; and
the terminal device of a guest.

8. An appointment management method comprising:
Setting a plurality of appointment slots prepared by a host in advance;
storing attribute information of a plurality of guests who make appointments from among the plurality of appointment slots in advance;
identifying candidate appointment slots for each guest based on the attribute information of each guest;
outputting the candidate appointment slots to a terminal device of each guest;
receiving a desired appointment slot which is selected by each guest from among the candidate appointment slots for each guest; and
assigning an appointment to each guest from among the plurality of appointment slots based on the desired appointment slot of each guest and the attribute information of each guest.

9. A non-transitory computer-readable recording medium containing an appointment management program that causes a computer to execute:
a step of setting a plurality of appointment slots prepared by a host in advance;
a step of storing attribute information of a plurality of guests who make appointments from among the plurality of appointment slots in advance;
a step of identifying candidate appointment slots for each guest based on the attribute information of each guest;
a step of outputting the candidate appointment slots to a terminal device of each guest, a step of receiving a desired appointment slot which is selected by each guest from among the candidate appointment slots for each guest; and
a step of assigning an appointment to each guest from among the plurality of appointment slots based on the desired appointment slot of each guest and the attribute information of each guest.
